(19) United States
(12) Patent Application Publication
(10) Pub. No.: US 2018/0027859 A1
(43) Pub. Date: Feb. 1, 2018

(54) PROCESS FOR THE CLEANING OF EDIBLE MUSHROOMS

(71) Applicant: AUREA CENTER SRL, 37854 Pergine Valsugana (tn) (IT)

(72) Inventors: Andrea Brugnara, I-38057 Pergine Valsugana (IT); Gianni Rosario Orefice, I-38057 Pergine Valsugana (IT); Marco Vanalli, 8 - 24020 SCANZOROSCIATE (BG) (IT)

(73) Assignee: AUREA CENTER SRL, 37854 Pergine Valsugana (tn) (IT)

(21) Appl. No.: 15/550,408

(22) PCT Filed: Feb. 12, 2016
(86) PCT No.: PCT/IB2016/050750

§ 371 Date: Aug. 11, 2017

(30) Foreign Application Priority Data
Feb. 13, 2015 (IT) RN2015A000004

(51) Int. Cl. A23L 31/00; A23B 7/00; A23L 11/30

(52) U.S. Cl. CPC A23L 31/00; A23L 11/30; A23B 7/00; A23V 2002/00

(57) ABSTRACT

The invention relates to a process for cleaning mushrooms intended for human consumption, that comprises the following steps:—separation from the mushrooms of the soluble parts through the generation of an extract;—cleaning the pulp of insoluble foreign elements;—reconstructing by combining the pulp, removed of soluble elements and cleansed of insoluble elements, with the extract; wherein the step of cleaning the pulp takes place at least during and/or after the generation of the extract.

The present invention concerns a process for cleaning mushrooms intended for human consumption of foreign elements. In particular, the process has been studied with particular reference to wild mushrooms, even more preferably of the boletaceae family (hereinafter called “boletus” for the sake of brevity), and even more preferably of the species called “boletus edulis”. However, this does not exclude other applications, like for example with respect to cultivated mushrooms.

In the field of edible mushrooms, it is known that wild ones have much better and more highly prized organoleptic characteristics than cultivated ones. However, they are often infested by insects that are located inside the pulp, including mycetophilidae larvae. As well as these, there can be other impurities and foreign bodies, like for example topsoil, pine needles, moss, grass, multiresidual substances, etc. Humans are unable to control and prevent these contaminations by foreign elements during the birth and growth of mushrooms, since wild mushrooms cannot be subjected to controlled cultivation.

Cultivated mushrooms are also not totally free from these problems, for example the topsoil is not completely removable with normal scrubbing processes.

The risk run by industries, especially for transformed products such as granulates, sauces or other, is the market withdrawal of large batches following official analyses that find the aforementioned problems.

Of course, the problem is contained by discarding the most contaminated mushrooms from the process, but this ends up excluding many organoleptically excellent mushrooms.

In this way, the industry ends up depending only on the level of cleaning of the batches of mushrooms that it manages to obtain as raw material to begin with. These batches, however, have characteristics that are also very different among themselves, for which reason the industry is unable to guarantee a product with constant values of consistency, smell and taste over time (let us think, for example, of processed products or risotto or pasta preparations), and even less so can it fulfil the demand of the market.

A preferred aim of the present invention is to totally or partially overcome the problems of the prior art.

Another preferred aim of the present invention is to provide a process for cleaning mushrooms intended for human consumption of foreign elements that ensures that the end product has appreciable and repeatable characteristics of smell, consistency and flavour.

Another further aim of the present invention is to provide a process that is adaptable to the state of contamination of the starting mushrooms.

A yet further aim of the present invention is to allow the industry to ensure that the market is supplied with constant amounts of processed product.

Another further aim of the present invention is to provide a process that ensures an appearance of the end product that is appreciated by the public, preferably similar to a normal dried mushroom.

According to a first general aspect thereof, the present invention concerns a process for cleaning mushrooms intended for human consumption of insoluble foreign elements. The invention has been made with particular reference to the extraction of foreign elements inside the pulp, but of course it also has a positive effect on the cleaning of external elements. The invention comprises the following steps:
separation of the soluble parts from the mushrooms through the generation of an extract through solvent;
cleaning the pulp of foreign elements
reconstruction by combining the pulp, removed of the soluble elements and cleaned, with the extract.

Preferably, the step of cleaning the pulp takes place at least during and/or after the generation of the extract.

The solutes are the noble elements of the mushroom, and contain flavours, smells, colour. By separating them, it is possible to intervene invasively on the pulp to also extract the undesired elements. Indeed, the invasive work can be functional for increasing the degree of extraction of the solutes, so that it can also be simultaneous or partially simultaneous with making the extract.

The mushroom reconstructed by combining the extract with the cleaned pulp has the advantage of being able to have repeatable organoleptic characteristics, since they depend on the amount of extract added.

Moreover, being able to clean any mushroom, irrespective of the degree of infestation, all discards are practically eliminated to the great benefit of the industry.

Finally, the process, by providing for a reconstruction of the mushroom, can have smell and flavour levels even more intense than the starting mushroom, since this depends on the amount of extract added to the pulp. The end product, despite having a practically unchanged fibrous structure, has a much more soluble aromatic component than the starting mushrooms, for which reason in making dishes like risotto or sauces, the impression on the palate is the same, but the mass of rice or sauce has an aroma that is stronger overall.

The inventors have found that a particularly effective cleaning step provides for the suspension of the pulp in a liquid medium, preferably water, to form a mixture, and the stressing of the mixture through at least one series of pressure variations that cause the foreign elements to come out.

The pressure variations, indeed, stress the pulp by dilating the cavities, such as the porosities, the gaps, the slits between the fibres, and the tunnels dug by the parasites, thus encouraging whatever is found inside to come out.

Said cleaning step preferably also comprises the removal from the mixture of the insoluble foreign elements that have come out from the pulp (for example by skimming and/or sieving and/or filtration) or the removal from the mixture of the treated pulp. The skimming or sieving can for example take place with the help of vibrations applied to the mixture. These can for example make the foreign elements emerge better.

Preferably, said variations comprise at least some pressure values below atmospheric pressure, for example they alternate maximum values with minimum values, where at least the lower values are below atmospheric pressure. Preferably, the pressure variations generate a pulsed stress, for the sake of simplicity called “pulsed vacuum”. It should be noted that it is possible to use durations of the pulses, and/or times between one pulse and another, and/or pressure values that are fixed or variable.

The inventors have also found that another particularly effective cleaning step, to be adopted in addition or as an alternative to the previous one, provides for the suspension of the pulp in a liquid medium, preferably water, to form a mixture, and the bubbling through the mixture of a food gas or of a mixture of food gases (for example it is preferable to bubble at least nitrogen gas and/or carbon dioxide), where the bubbling of the gas causes the foreign elements to come out from the pulp in suspension.

This cleaning treatment is particularly effective against dead mycetophilidae larvae that are located in the pulp. The gas (especially nitrogen) indeed, “inflates” the larvae like small balloons, and having a tendency to rise, being volatile, leads them to float on the surface of the mixture.

Preferably, said step also comprises the removal from the mixture of the foreign elements that have come out from the pulp (for example by skimming and/or sieving and/or filtration) or the removal from the mixture of the treated pulp. The skimming or sieving can for example take place with the help of vibrations applied to the mixture. These for example can make the foreign elements emerge better.

The inventors have also found that another particularly effective cleaning step, to be adopted in addition or as an alternative to one or both of the previous ones, provides that the pulp, (preferably that removed of the soluble elements through the step of generating an extract), is placed in suspension in a solution comprising oxygenated water, to generate a mixture, for a predetermined time, where the reaction of the oxygenated water inside the pulp generates a propulsion effect that causes the foreign elements to come out.

Preferably, said suspension of the pulp in a solution comprising oxygenated water is at least partially after said separation step.

Even more preferably, the pulp is previously separated from the extract to be placed in suspension in the oxygenated water solution.

Said cleaning step also comprises the removal from the mixture of the insoluble foreign elements that have come out from the pulp (for example by skimming and/or sieving and/or filtration) or the removal from the mixture of the treated pulp. The skimming or sieving can for example take place with the help of vibrations applied to the mixture. These, for example, can make the foreign elements emerge better.

According to some preferred embodiments of the invention the step of generating the extract is at least partially simultaneous with the cleaning steps with pressure variation and/or bubbling, since the mixture to carry out one and/or other of these is obtained by placing the mushrooms and/or the pulp to be cleaned in said liquid medium that acts as a solvent to at least partially generate said extract.

Preferably, in the case in which both at least one cleaning step by pressure variation and at least one cleaning step by bubbling are applied, the first happens before the second.

If at least one cleaning step with oxygenated water is used, it is preferable for at least two parts of pulp to be kept in the mixture with oxygenated water for mutually different predetermined times, so as to undergo different amounts of bleaching.

Since the pulp, in the step of generating the extract, took on a substantially uniform colour, this allows the pulp to be bleached to mimic, respectively, the stalks (whiter) and the caps (less white) of the starting mushrooms.

According to a preferred general characteristic of the invention said reconstruction step comprises the step of subjecting the cleaned pulp to a drying process during which said extract is combined (preferably periodically) with the pulp (preferably by spraying but other soaking systems are not ruled out, preferably the selected combining system is such as to allow the amount of extract combined with the pulp to be controlled). In this way it is possible to easily control the degree of flavour returned to the pulp, (for example through the number of combining cycles and/or the amount of extract combined and/or the soaking time) and thus make the characteristics of the end product constant or personalise them. Finally, through the drying and combining of the solute it is also possible to control the consistency and the mass returned to the pulp.

In general, it should be observed that the process of the present invention is highly personalisable based on the level and type of contamination of the starting mushrooms to be processed. The personalisation can advantageously take place by providing for an initial step of analysis of the level and/or type of contamination of the starting mushrooms to be cleaned and assigning a number and/or type of washes to them, each coinciding with a cleaning step according to claims 2 and/or 3 and/or 4 or claims dependent thereupon, where said number and/or type is dependent on said level of contamination detected, said washes are then carried out on said mushrooms to be cleaned.

Such personalisation can easily be automated by providing for a predetermined number of assignable washing programs, each associated with a range of values identifying the degree and/or type of contamination.

The analysis and a consequent program can be associated with an entire batch of mushrooms. Or the mushrooms of a batch can be separated and grouped together in various groups with similar contamination characteristics, and each group can be automatically associated with a cleaning program. In this case, the analysis is preferably piece by piece; for example, analysis and separation of mushrooms and/or their pieces are continuous when transiting along a production line.

According to another preferred general characteristic of the invention the mushrooms to be cleaned are subjected to a series of washes by pressure variation and/or bubbling in succession one after the other, where the extract is at least partially used as liquid phase of the suspension of at least some of said washes to become enriched with solutes at each subsequent wash in which it is present.

For example, in the first washing step the liquid phase can also be only a pure solvent, preferably water, which becomes enriched during the washing with solutes and generates a first extract, which participates as liquid phase in all subsequent washes where it becomes enriched.

Further features and advantages of the present invention will become clearer from the following detailed description of preferred embodiments thereof, given for illustrating and not limiting purposes.

According to a first preferred embodiment the starting material used for the process are “boletus” mushrooms in dried state, more preferably in slices and/or crumbs.

The use of dried material allows easy storage which avoids dependence on the seasonality of these wild mushrooms.

Dried mushrooms are placed in suspension in a solvent, preferably water, so as to encourage the soluble elements to come out and the formation of an extract. More preferably, the water has a temperature higher than room temperature so as to accelerate extraction, for example it is between 30° C. and 90° C.

During this infusion, a stress is applied to the mixture of water and mushrooms through repeated pressure variations, for example in the form of pressure waves or pulses. The variations are obtained, for example, by lowering the pressure to values below atmospheric pressure alternating with rises to atmospheric pressure and/or to pressure values above atmospheric pressure. This procedure can for the sake of simplicity be called “pulsed vacuum”.

Thereafter a food gas or a mixture of food gases are bubbled through the mixture of water and mushrooms. Preferably, nitrogen gas is used.

The steps of extraction, pressure variation and bubbling take place on the same mixture of water and mushrooms, so that at each subsequent step the extract becomes increasingly enriched with soluble elements of the mushrooms, which by gravity tend to fall to the bottom of the mixture.

It is possible to repeat a desired or programmed number of pressure variations and/or bubbling steps.

After these cleaning steps, which has generated, in addition to the extract, also the exit from the pulp of many insoluble foreign elements, like for example larvae, the extract is separated from them.

It should be observed that the insoluble foreign elements, once they have come out from the pulp through the pressure variations and/or the bubbling, can be separated with any suitable system.

For example, during bubbling said elements and in particular larvae tend to float on the mixture, for which reason they can be eliminated for example by skimming. In addition or alternatively, it is possible to provide for a recirculation circuit that takes the extract from the task in which the suspension is located and takes it back to the same tank, after it has been filtered along the recirculation path. In addition or alternatively, it is possible to use sieving.

The pulp removed of the soluble elements, by means of the extract, and cleaned of insoluble foreign bodies, by means of the expulsion with pressure variations and/or bubbling, may still contain some foreign bodies inside it. This is the case, for example, of larvae fragments.

For this reason, the pulp can be subjected to a further cleaning treatment.

In this subsequent step, the pulp separated from the extract is placed in suspension in another liquid phase, to generate a new solute-poor mixture. The liquid phase this time is an oxygenated water solution. Preferred dilution values of the oxygenated water are, in percentage by weight over the total weight, within the following range [0.3%-15%].

The oxygenated water by reacting causes an expulsion of the residues of larvae or other foreign elements from the pulp. The action is very invasive, but takes place on pulp already deprived, or almost entirely deprived, of the noble components, i.e. the solutes. The expulsion is again promoted more if at least one stressing by pressure variation took place beforehand, so as to have the pores widened.

The sitting in the oxygenated water solution, as well as the expulsion of the foreign elements, also causes the bleaching of the pulp, which up to here had a very uniform brown colour due to it having been in prolonged contact with the extract.

Preferably, the pulp does not all stay in the oxygenated water solution for the same time period, but at least two parts of pulp stay for different times so as to undergo different degrees of bleaching. For example, one part is extracted first to bleach less. In this way, it is possible for example to mimic the colour of the stalks and the colour of the caps of porcini mushrooms. The same result can be obtained, alternatively, by immersing the at least two parts of pulp in a solution with different percentages of oxygenated water. The two techniques can of course by combined with each other, controlling the permanency times.

After bleaching the pulp is redried, for example through a fluid bed dryer. During drying the pulp is repeatedly wetted, for example by spraying, with the extract, so as to regain the solutes and the desired consistency. Of course, this does not exclude the use of other techniques, in addition or as an alternative to spraying, which allow the pulp to be wetted with the extract cyclically during drying. It is easy to obtain a product totally resembling dried mushrooms, for example in slices and/or crumbs or granulate, especially using both the more bleached pulp and the less bleached pulp to mimic the stalks and the caps.

### EXPERIMENTAL EXAMPLE

amount of mushrooms and water to form the suspension: in proportion of 1 to 10
temperature of suspension water: room
parameters of the pulsed vacuum and duration: 5 cycles in 5 minutes
parameters of the bubbling and duration: continuous bubbling for 5 minutes.
parameters of the use of oxygenated water and duration: 5% dilution, immersion for 10 minutes.

In these conditions an elimination from inside the pulp of 96% of insoluble foreign elements was obtained.

In general, it should be observed that other types of cleaning treatment of the pulp in addition to the ones indicated are not excluded. Nor is the application of only one or some of the types of washing indicated ruled out.

For example, the programming of the number and type of washes to be applied can depend on an initial analysis of the mushrooms to be treated which establishes the amount and/or type of foreign elements to be eliminated.

This can be done for example through a production line that has an initial analysis station of the mushrooms and a series of cleaning programs able to be activated according to the contamination detected.

The system could also have a station in which each mushroom is analysed and it is sent to sub-lines with different cleaning programs according to its degree of contamination.

It should also be observed that up to here stressing treatments by pressure variation and bubbling treatments have been described, carried out in the same container and on the same mixture of mushrooms and water. This makes it more practical to apply various successive washing steps with pressure variation and/or bubbling. However, this does not rule out less preferred embodiments in which in each wash the pulp and the extract are separated, to constitute a new suspension in new water at the next cycle, in which the extract can be added at least in part. Or it is not ruled out to have washing cycles by pressure variation and/or bubbling that each take place in distinct containers, for example arranged in successive stations of a production line, each containing its own liquid phase for the suspension.

Those skilled in the art will also note that, although a process is described herein that uses dried mushrooms as starting material, it is also possible to start from other states of mushrooms, like for example fresh and/or frozen mushrooms, to the great benefit of the industry in terms of availability on the market and not being restricted by the seasonality of the product.

Of course, the embodiments and the variants described and illustrated heretofore are purely examples and those skilled in the art, in order to satisfy specific and contingent requirements, can bring numerous modifications and variants, including for example the combination of said embodiments and variants, all in any case covered by the scope of protection of the present invention as defined by the following claims.

1. Process for cleaning mushrooms intended for human consumption of foreign elements, wherein the foreign elements have soluble elements and insoluble elements, wherein the mushrooms comprise a pulp comprising the following steps:
separation from the mushrooms of the soluble elements through generation of an extract;
cleaning the pulp of the insoluble foreign elements.
reconstruction by combining the pulp, removed of the soluble elements and cleansed of the insoluble elements, with the extract,
wherein the step of cleaning the pulp takes place at least during and/or after the generation of the extract.

2. Process according to claim 1, wherein the cleaning step further comprises creating a suspension of the pulp in a liquid medium, and stressing the suspension, through at least one series of pressure variations that cause the foreign elements to come out.

3. Process according to claim 1 or 2, wherein the cleaning step further comprises creating a suspension of the pulp in a liquid medium and bubbling of a food gas or of a mixture of food gases, wherein the bubbling of the gas or of the mixture of gases causes the foreign elements to come out from the pulp in suspension.

4. Process according to claim 1, wherein the cleaning step further comprises creating a suspension of the pulp in a solution comprising oxygenated water for a predetermined time, wherein the reaction of the oxygenated water inside the pulp generates a propulsion effect that causes the foreign elements to come out.

5. Process according to claim 2 or 3, in which the separation step is at least partially simultaneous with the cleaning steps.

6. Process according to claim 5, in which the cleaning step comprises the pressure variations according to claim 2 applied before the bubbling according to claim 3.

7. Process according to claim 4 in which the suspension of the pulp in a solution comprising oxygenated water takes place at least partially after the separation step according to claim 1.

8. Process according to claim 7, in which the pulp is separated from the extract before being placed in suspension in the oxygenated water solution.

9. Process according to claim 4 in that in which at least two parts of pulp removed of solutes are kept in the suspension with oxygenated water for mutually different predetermined times, so as to undergo different amounts of bleaching.

10. Process according to claim 1, in which the reconstruction step further comprises subjecting the cleaned pulp to a drying process wherein the extract is combined with the pulp.

11. Process according to claim 1, further comprising an initial step of analysis of a level and/or type of contamination of the mushrooms and assigning a number and/or type of washing to the mushrooms, each coinciding with a cleaning step according to any one of the preceding claims, wherein said number and/or type is dependent on the level of contamination detected.

12. Process according to claim 2 or 3 in which the mushrooms are successively subjected to a series of washing operations, each coinciding with a cleaning step according to any one of the preceding claims, wherein the extract is at least partially used as liquid phase of the suspension of at least some of the washing operations to become enriched with solutes in each subsequent wash in which it is present.
